(19) United States
(12) Patent Application Publication
(10) Pub. No.: US 2004/0051884 A1
(43) Pub. Date: Mar. 18, 2004

(54) Method of encoding raster data based on variations of color

(75) Inventor: Timothy H. Saxton, Surrey (CA)

Correspondence Address: OYEN, WIGGS, GREEN & MUTALA, 480 - THE STATION, 601 WEST CORDOVA STREET, VANCOUVER, BC, V6B 1G1, CA

(73) Assignee: Creo, Inc.

(21) Appl. No.: 10/247,321

(22) Filed: Sep. 18, 2002

(51) Int. Cl. H04N 1/60

(52) U.S. Cl. 358/1.9; 358/518

(57) ABSTRACT

A system and method for reducing the volume of data necessary to represent an image by utilizing tiling and imagemasking techniques is disclosed. Initially, an image described by raster content having an original number of bits per pixel is provided. The image is divided into tiles such that each of the tiles represents a portion of the image. Then, for each of the tiles, a determination is made on how best to represent the tile, as a collection of rectfills, imagemasks, raster data or a combination thereof. Once each tile has been converted, the new image is then saved.

### FIELD OF THE INVENTION

The present invention relates generally to image compression techniques for digital images and, more particularly, to an image compression technique incorporating filling and imagemasking linework components of a digital image.

### BACKGROUND OF THE INVENTION

Digital imaging systems have improved the process of creating, editing and rendering images. In particular, digital imaging systems have decreased the amount of processing time necessary to render an image. Nonetheless, the ability of digital imaging systems to process and, particularly, to render images remains limited by the memory capacity of digital imaging systems.

In digital imaging systems, an image is often divided into a rectangular grid defined by fixed spatial coordinates. Each grid element defines a sample point having one color. Each sample point is referred to as a picture element, commonly known as a pixel or a “dot” (not to be confused with the halftone dot used in the printing industry). Such an image is usually referred to as a raster image and is typically represented and stored in a format that uses several bits per pixel to identify the color of each pixel. The total amount of data necessary to represent an image depends on several factors, some of which include the image size, the resolution of the image, and the number of bits per pixel.

Large high-resolution images, particularly those containing “continuous tone,” “contone” or “CT” content (multiple bits per color component per pixel), require an extensive amount of data to represent the images. Because image rendering devices have limited memory and processing capacity, large high-resolution images often place a demand on image rendering devices that exceeds the image rendering capabilities of the devices. As an example, a typical Raster Image Processor (“RIP”) would not be able to handle the volume of printing format data in a 1200 dot per inch (“dpi”) image file represented in contone raster format. Such a file might contain the imaging data required for a map. For example, a file for printing a 32 inch by 44 inch sized image formed of 1200 dpi, 8 bits-per-pixel elements would require about 2 gigabytes of memory, well beyond that available to most rendering/RIP workstations. In many practical applications, such images consist of some photographic content and a large portion of “linework” (“LW”) data, i.e., text or geometric objects that delineate areas of constant color that are easily compressible, i.e., amendable to representation with a small number of bits per pixel.

One method of reducing the data volume of high resolution images is to divide the image into tiles, which can be handled more easily than full images. Rectangular portions of the tiles can then be “filled,” allowing the same information that was in a related portion of a raster image to be represented by a much smaller volume of data. An example of such a filling method is described in a U.S. Patent Application titled SYSTEM AND METHOD FOR REDUCING THE DATA VOLUME OF IMAGES, U.S. patent application Ser. No. 09/710,183, filed Nov. 9, 2000, the subject matter of which is hereby incorporated by reference. As described in this application, the “filled” rectangular portions are referred to as “rectfills.” More specifically, a rectfill is a rectangular area of an image filled with a single color. Filling is accomplished by defining the coordinates of the area and designating a single color with which to fill the area. The coordinates can define a rectangular area as small as a single pixel or a rectangular area covering a large number of pixels. The single color can be defined in terms of CMYK or RGB values or a spot value and a possible transparency value. A further explanation at rectfills and issues related to their use is described in U.S. patent application No. ______, titled METHOD OF COMPENSATING FOR SCAN CONVERSION RULES AND IMPOSITIONS SHIFTS, filed concurrently herewith (attorney docket number CREO-1-18870), the subject matter which is hereby incorporated by reference. One drawback with employing only rectfills to reduce data volume is that in some images, rectfills are not an efficient tool for reducing image data volume and/or computational complexity.

Therefore, a need exists for a method of reducing the volume of data representing high resolution images. A need also exists for reducing the volume of data representing special high resolution images with LW data that is not amenable to efficient representation with rectfills. More specifically, a need exists for a unified method of reducing the volume of data representing different types of high resolution images so that the images can be efficiently processed and rendered in digital imaging systems.

### SUMMARY OF THE INVENTION

The present invention provides a system and method of increasing the efficiency of processing digital images by reducing the data volume with of linework data. The invention is preferable used with tiled images and can be used when a tiled image is created for storage, or whenever it is suitable to reduce the data volume of a tiled image. In accordance with other aspects of the invention, color spaces are determined for the linework elements of an image, which are then used to represent the linework information of the digital image as rectfills and/or imagemasks. In a further aspect of the invention a determination is made whether it would be more efficient to represent a particular linework element as an imagemask or a plurality of rectfills.

In accordance with still further aspects of the present invention, the criteria used to determine whether an imagemask or a plurality of rectfills is used to represent linework elements may be any suitable criteria. Suitable criteria include, but are not limited to a threshold number of rectfills per tile, a pixel coverage threshold for a tile or a threshold number of line elements.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an exemplary computing device suitable for executing an image processing routine formed in accordance with the present invention.

FIG. 2 is a flow diagram of an image processing routine formed in accordance with the present invention.

FIG. 3 is a flow diagram of an LW conversion subroutine suitable for use in FIG. 2.

FIG. 4 is a flow diagram of a LW color space determination subroutine suitable for use in FIG. 3.

FIG. 5 is a flow diagram of a solid colors subroutine suitable for use in FIG. 4.

FIG. 6 is a flow diagram of a semitransparent colors subroutine suitable for use in FIG. 4.

FIG. 7 is a flow diagram of a spot mixed subroutine suitable for use in FIG. 6.

FIG. 8 is an example of a tile of pixels including rectfill and imagemask areas.

### DETAILED DESCRIPTION OF A PREFERRED EMBODIMENT

The present invention is directed to a system and method that reduces the volume of data required to represent an image by utilizing tiling, imagemasking, and/or indexing techniques.

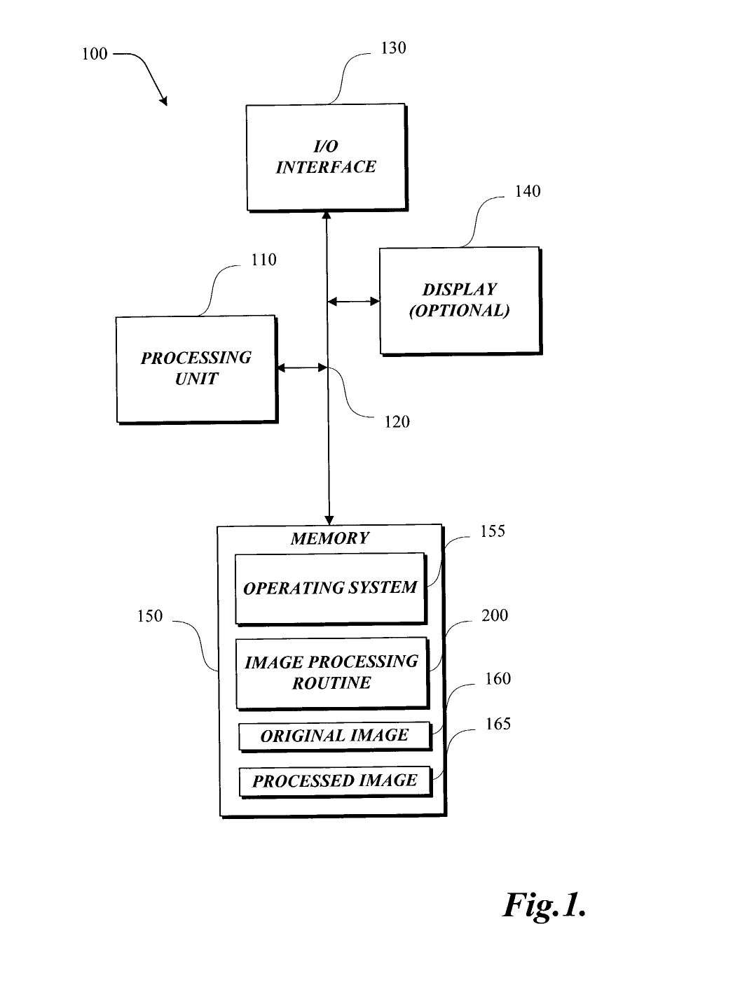

FIG. 1 is a simplified block diagram of an image processing device 100 suitable for implementing embodiments of the present invention. As will be described in further detail below, the image processing device 100 includes a processing unit 110 suitable for receiving and processing an original digital image 160. The original digital image 160 is created using methods well known in the art. The original digital image 160 is stored in a memory 150 in computer-readable file having a file format for representing bit-mapped graphic data either directly or in an indexed manner. Examples of such file formats include tagged image file format (“TIFF”), TIFF for Information Technology (“TIFF/IT”), Scitex Handshake or native, and others. In such formats, the original digital image includes a plurality of pixels. Each of the pixels in the original image is represented by an original number of data bits, which may be an index, necessary for describing the characteristics of the pixel, such as color.

Initally, the original image 160 is transmitted to the image processing device 100 from any data source including, but not limited to, a local data source such as a computer workstation or server directly connected to the image processing device 100, a remote data source, or a computer-readable medium storing the original image, such as a CD-ROM disc. In this regard, the image processing device 100 includes an input/output interface 130 for receiving the transmitted original image 160. The original image 160 is stored for retrieval in the memory 150 of the image processing device 100.

The memory 150 also stores data and instructions necessary for reducing the volume of data representing the original digital image 160 for execution by the processor 110. More specifically, the memory 150 stores an image processing routine 200 formed in accordance with the present invention for reducing the volume of data representing the original image by using tiling, imagemasking and/or indexing techniques. Once the processor 110 executes the image processing routine 200, a processed image 165 is produced. The processed image 165 can be transmitted to another device for further processing or may be stored in the memory 150 for further processing by the image processing device 100.

It will be appreciated by those skilled in the art and others that the processing device 100 can be a general purpose computer workstation or can be located within a RIP or any suitable image rendering device. Accordingly, the processed digital image 165 can be directly transferred to other processes typically implemented by any of these devices.

As will be described in further detail below, the image processing routine 200 reduces the volume of data necessary to represent an image (or at least increases the speed of processing), in a format such as PostScript or Portable Document Format (“PDF”), which accommodates a mixture of raster formats, by using tiling and/or imagemasking techniques. Generally, the image to be processed is divided into smaller sub-areas or tiles. Each of the tiles is individually analyzed to determine whether an increase in efficient processing is possible and worthwhile. One way this can be accomplished is by comparing the number of bits per pixel required to represent the tile, if the data reduction methods of the present invention are utilized, with the original number of bits per pixel describing the image. If an increase in efficiency is possible and worthwhile, the data processing methods of the present invention are used.

As used in this description, the “color” of a pixel is not necessarily restricted just to the intensity for each component of a color space, such as red-green-blue (“RGB”) or cyan-magenta-yellow-black (“CMYK”). CMYK are the printing process colors, often referred to as simply process colors. In addition to these components, the colors used the raster file can include spot colors, which are uniquely defined colors which cannot be defined by the standard “RGB” or “CMYK”. The color components are also called color separations, or simply separations. For instance, a raster file may have six separations consisting of the printing process colors CMYK and two spot colors. Each color that is used in the raster file will have a color definition that defines for every color (separation) component the amount of that component, from 0% to 100%. Each color can also include a transparency property. Each color component of a color can be either 0% transparent or 100% transparent. As will be appreciated by those skilled in the art and others, a representation of an image may specify a “default” color (possibly white but also commonly colorless) so that any pixel of the default color does not need to be represented explicitly. Such specification eliminates the need to explicitly represent the pixels in a tile that have the default color. Further, a tile that consists entirely of the default color requires no representation at all.

Additionally, in one embodiment of the present invention, a given tile may have a designated “background” color, which is typically the dominant color in the tile. If the background color differs from the default color, it is necessary to explicitly represent the background color, typically with a “fill” instruction, which requires negligible storage. All pixels in such a tile are taken to be the background color unless explicitly specified otherwise, i.e., unless explicitly specified by an “imagemask” or “rectfill” indicating that the pixels are some other particular color. More precisely, a imagemask is a reduced bit-per-pixel (often a 1-bit-per-pixel) raster image. A rectfill is a rectangular area of an image filled with a single color. A one-bit-per-pixel imagemask is applied to an area of an image by first selecting a color. Then, for each pixel of the imagemask having the value 1, the corresponding pixel of the image area to which the imagemask is applied is changed to the selected color. For each pixel of the imagemask having the value 0, the corresponding pixel of the image area to which the imagemask is applied is left unchanged. As will be appreciated by those skilled in the art and others, the roles of the values 0 and 1 may be exchanged in a particular implementation. It should be noted that in some picture representation systems (including PostScript and PDF) the only pixels that are colorless are pixels that are never “marked” or “painted”. In such systems, it is not possible to fill with a non-colorless background color and, then, designate certain pixels as colorless.

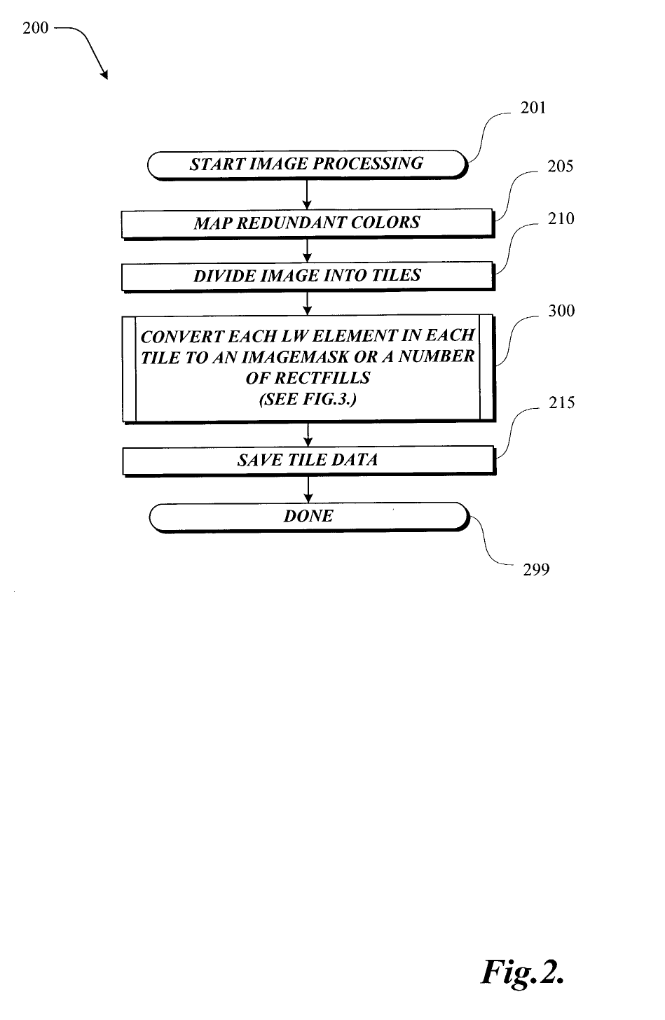

FIG. 2 is a flow diagram illustrating the logic of an exemplary image processing routine 200 formed in accordance with the present invention and implementable by the image processing device 100 shown in FIG. 1. Beginning at block 201 and proceeding to block 205, redundant colors in the original image are mapped to a uniform representation. For example, an illustrative image may have two equivalent green colors designated “dark green” and “forest green.” If the color values (either RGB, CMYK or spot values) of the green colors are the same, in the interest of reducing image size and increasing efficiency, the green colors are mapped to a single representation based on their same color values.

Next, in block 210, the original image 160 is divided into tiles or blocks such that each tile represents a portion of the overall image. This can be accomplished in a static fashion based on predetermined size or in a dynamic fashion based on tile content. Thus, the tiles may be uniform or variable in size. As will be appreciated by those skilled in the art and others, in an alternate embodiment tile sizes may vary from tile to tile. In one exemplary embodiment of the invention, given current resolutions of approximately 2400 dpi, the size of the tiles was effectively balanced in a range between 512 to 4096 pixels by 512 to 4096 pixels. The number of tiles into which the image was divided varies depending upon the number of colors represented in each tile and the image resolution. Images with less colors had less need for smaller tiles to achieve a low level of colors per tile. One of the purposes of dividing an image into tiles is to create smaller areas with fewer colors. Such tiles need less data to represent the image than required by the original raster content.

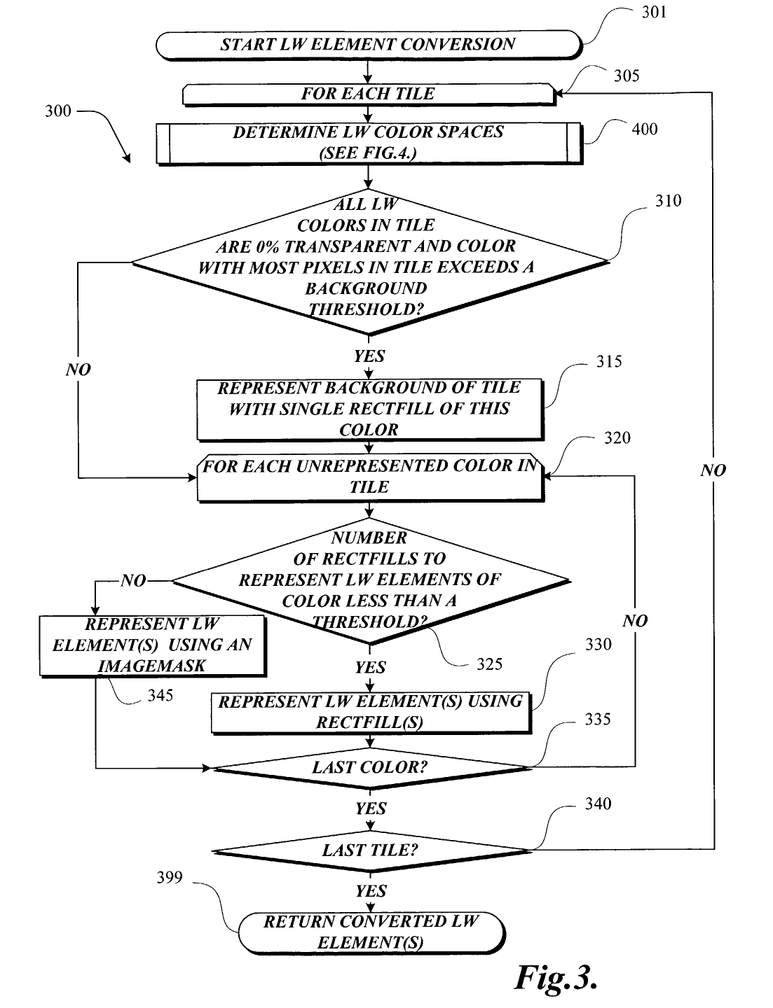

Continuing the logic of routine 200, next, in subroutine block 300 each linework (LW) element in each tile is converted into imagemask(s) or rectfill(s). A suitable image conversion subroutine 300, is illustrated in FIG. 3 and described below. After the original image 160 has been converted into the processed image 165 (made up of the tile data), the tile data is saved in block 215. Routine 200 then ends at block 299.

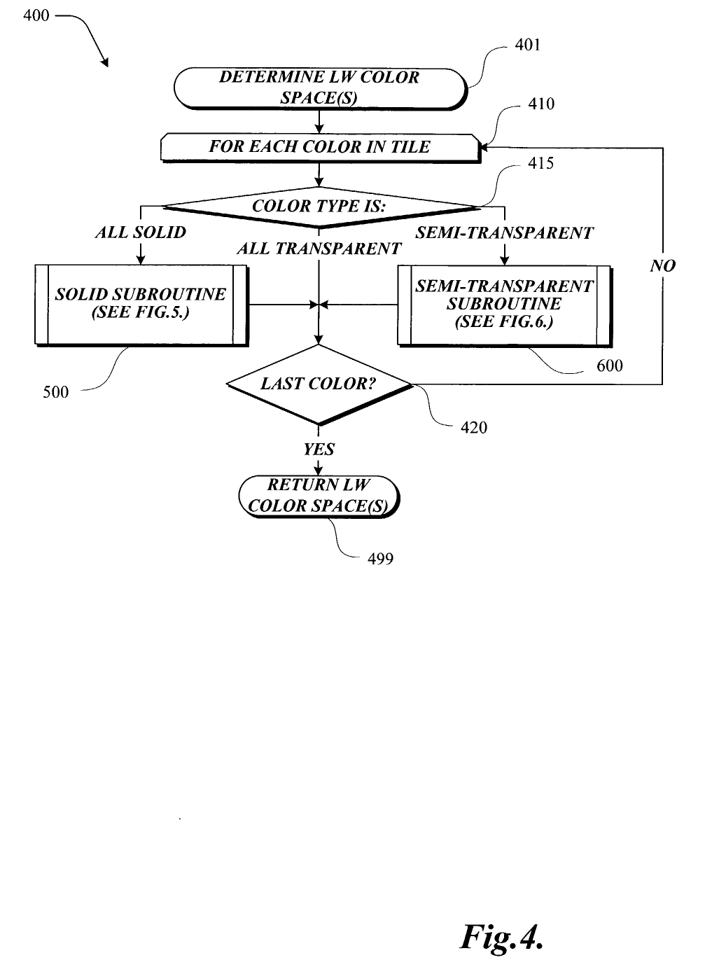

FIG. 3 is an exemplary subroutine suitable for use in FIG. 2 to convert linework elements in image tiles. The linework (LW) element conversion subroutine 300 begins in block 301 and proceeds to looping block 305, which forms an outer loop that iterates through each tile in an image. Next, in the outer loop, subroutine block 400 determines the color space for each linework element in the current tile. A suitable linework color space determination subroutine 400 is illustrated in FIGS. 4-7 and described below. After processing returns from subroutine block 400, in decision block 310 a test is made to determine if all linework colors in the tile are solid colors (i.e., are all 0% transparent) and if the color with the most pixels in the tile exceeds a background threshold. This test is made to determine whether the background of the current tile should be covered by a single rectfill of the color with the most pixels. If decision block 310 determines that all the linework colors in the tile are solid and that there is a color with the most pixels that exceeds a background threshold, the background of the tile is represented with a single rectfill of this color. See block 315.

After the background has been represented (block 315), or if decision block 310 fails, processing continues to a nested looping block 320 that iterates through each unrepresented color in the current tile. Processing continues in the nested loop to decision block 325 where a determination is made whether the number of rectfills required to represent the linework element(s) of the current color are less than a rectfill threshold (fixed threshold, variable threshold, or some other rectfill criteria is met). If so, as shown by block 330, the current linework element(s) are represented using one or more rectfills. Alternatively, as will be appreciated by those of ordinary skill in the art and others, pixel coverage may be used to determine if rectfills or imagemasks should be used. Still further, the rectfill criterion may be a predetermined (either fixed or variable) threshold number of LW elements. If, however, in decision block 325, it is determined that the number of rectfills required to represent the linework element(s) of the current color exceeds a rectfill threshold, processing continues to block 345 where the linework element(s) are represented using an imagemask. It will also be appreciated by those of ordinary skill in the art that the rectfill threshold may be a static threshold or may vary and adapt based on image or tile characteristics (size, colors, resolution, etc.).

In one exemplary embodiment of the invention, the area in a tile for which an imagemask is provided is minimized by determining the minimal area (bounding box) in which the current color is located. This is accomplished by determining the minimum and maximum horizontal and vertical coordinates in the tile where the current color is located. Using the resulting information, the boundaries of the minimal area are determined. The imagemask for the current color is provided in the identified minimal area only. For example, instead of storing a 1-bit-per-pixel imagemask of 500 by 500 pixels to represent a circle with a diameter of 200 pixels in a square tile of 500 by 500 pixels only the information representing the smallest square containing the circle, i.e., 1-bit-per-pixel imagemask of 200 by 200 pixels plus the information about the position of the imagemask within the larger square needs to be stored. In general, it is more efficient to use only rectfill or imagemasks in each tile. In some instances a reduction in storage size may decrease efficiency if the stored image is too complex.

In any case, after either representing the linework element(s) of the current color as one or more rectfills (block 330) or as an imagemask (Block 345), processing continues to decision block 335 where determination is made whether this is the last color in the tile. If not the last color, processing loops back to nested looping block 320. If this is the last color, processing continues to decision block 340 where a determination is made whether this is the last tile of the image. If not, processing loops back to looping block 305 where a new tile is processed. If in decision block 340 it is determined that this is the last tile, which means that all linework elements of all colors have been converted into either imagemasks or rectfills, linework element conversion subroutine 300 returns the converted linework elements as shown by block 399.

Prior to converting linework elements into imagemasks or rectfills, each tile has to be analyzed to determine the color spaces of its linework elements. Different types of color spaces are assigned to the imagemasks or rectfills in a manner that define the color separations that will be marked by the imagemasks or rectfills. It will be appreciated by those of ordinary skill in the art that PostScript and PDF imaging modes are suitable for use in the present invention, including such features a Separation color space, DeviceCMYK color space, DeviceN color space, and over printing.

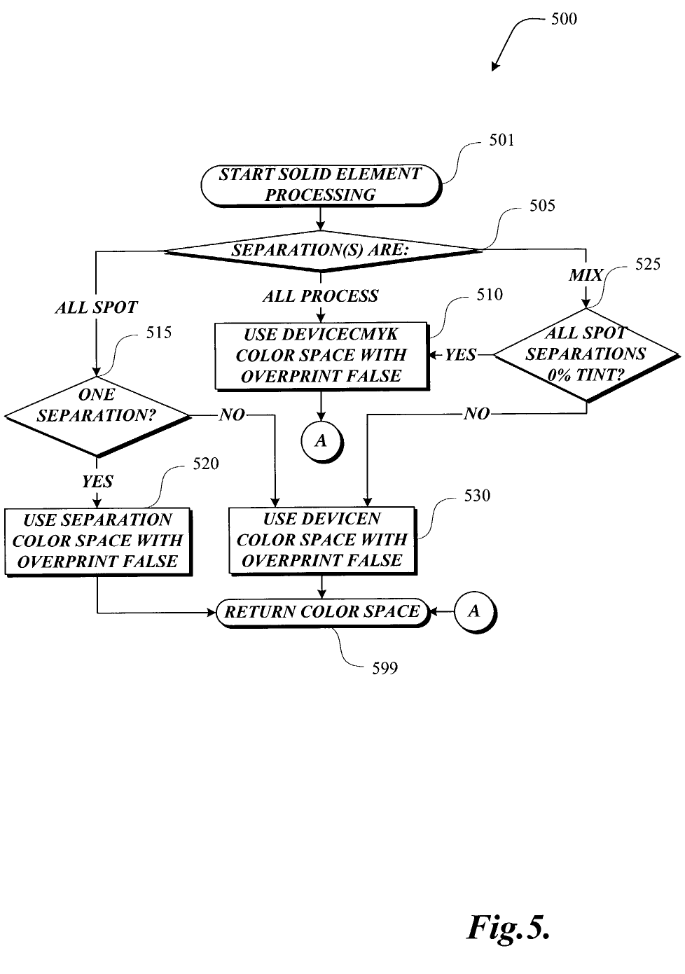

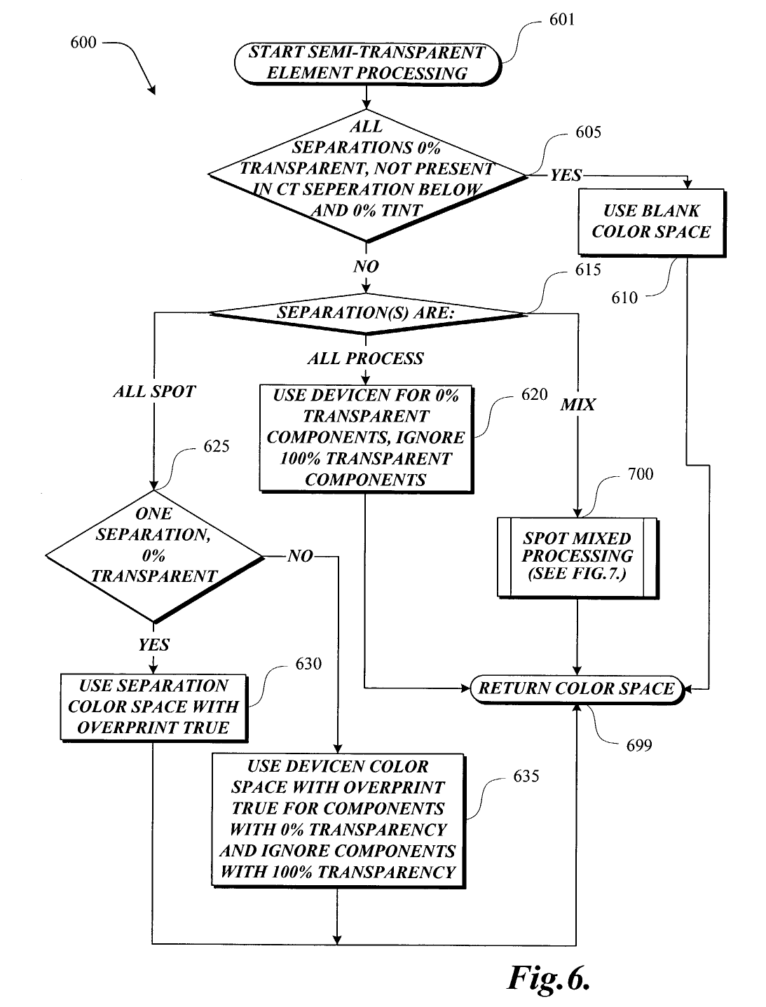

FIGS. 4-7 illustrate exemplary subroutines for determining linework color spaces. The linework color space determination subroutine 400, shown in FIG. 4, begins at block 401 and proceeds to looping block 410. Looping block 410 iterates through all of the linework elements of a tile. First, in decision block 415, a test is made to determine the color type (solid, transparent, or semi-transparent) of the current linework element. If the color type is solid (i.e., all separations are 0% transparent), processing continues to a solid subroutine 500 (illustrated in FIG. 5 and described below). If however, in decision block 415, it is determined that the color type is semitransparent (i.e., some separations are 100% transparent), processing continues to a semitransparent subroutine 600 (illustrated in FIG. 6 and described below). After the solid subroutine 500 or semitransparent subroutine 600 is finished, or if the color type is found to be transparent in decision block 415, processing continues to decision block 420, where a test is made to determine if the last linework element has been processed. A transparent color type (i.e., all separations are 100% transparent), does not require further processing (effectively a blank or null color space) because a transparent color type does not effect the end image. Thus, it can be safely ignored. If in decision block 420 it is found that the last linework element has not been processed, processing loops back to looping block 410. Otherwise, processing continues to block 499 where routine 400 ends and the color spaces that have been found are returned to the element conversion subroutine (FIG. 3).

FIG. 5 illustrates a solid linework element processing subroutine 500 suitable for use in FIG. 4. The solid element processing subroutine 500 begins at block 501 and proceeds to decision block 505 where a test is made to determine the type of “solid” separations—spot, process, or mix. If the separation(s) are all spot separations, processing continues to decision block 515 where a test is made to determine whether a single separation is used. If a single separation was used, processing continues to block 520 where a “separation color space with overprint false” is used for LW color space. If, however, in decision block 515 it was found that more than one separation was used, processing proceeds to block 530 where a “DeviceN color space with over print false” is used.

Returning to decision block 505 if it was found that the separations are a mixed separation (spot and process separations), processing continues to decision block 525. In decision block 525 a test is made to determine whether all spot separations in the mixed separation are 0% tint, meaning that the spot colors would not be printed. If it was found that all spot separations are 0% tint, essentially the separations should be rendered as process separations and processing continues to block 510 to be handled as such. Similarily, if in decision block 505 it was found that all separations are process separations, processing continues to block 510 where the “deviceCMYK color space with over print false” is used for the LW color space. After a LW color space has been determined in either block 510, 520 or 530, processing proceeds to block 599 where subroutine 500 ends and the determined color space is returned to the color space determining subroutine (FIG. 4).

FIG. 6 illustrates a semitransparent element processing subroutine 600 suitable for use in FIG. 4. The semitransparent element processing subroutine 600 begins at block 601 and proceeds to decision block 605 where a test is made to determine if all separations are 0% transparent, all these separations have no contone separations below the linework, and all these separations are all 0% tint. If so, processing continues to block 610 where a blank (null) color space is used because there is no need to represent or render this linework element. Processing then proceeds to block 699 and returns to the calling subroutine, i.e., the color space determining subroutine (FIG. 4). If, however, it was determined in decision block 605 that one of the conditions was not met, processing proceeds to decision block 615 where a test is made to determine what type of semi-transparent separations—spot, process, or mix. If in decision block 615 it is determined that the linework element has a spot separations, processing proceeds to decision block 625 where a test is made to determine if there is only one separation and it is 0% transparent. If so, in block 630, a separation color space with over print true is used. Then, processing proceeds to block 699.

If, in decision block 625 it was found that more than one separation is 0% transparent, then processing proceeds to block 635 where the color space used is a DeviceN color space with over print true for components with 0% transparency and components with 100% transparency are ignored. Processing then proceeds to block 699 where the color space is returned to the calling subroutine, i.e., the color space determined in subroutine (FIG. 4).

Returning to decision block 615 if it was found that the separations are process separations, then, in block 620, a DeviceN color space is used as the LW color space for the 0% transparent components and the 100% transparent components are ignored. The color space is then returned to the color space determination subroutine (block 699).

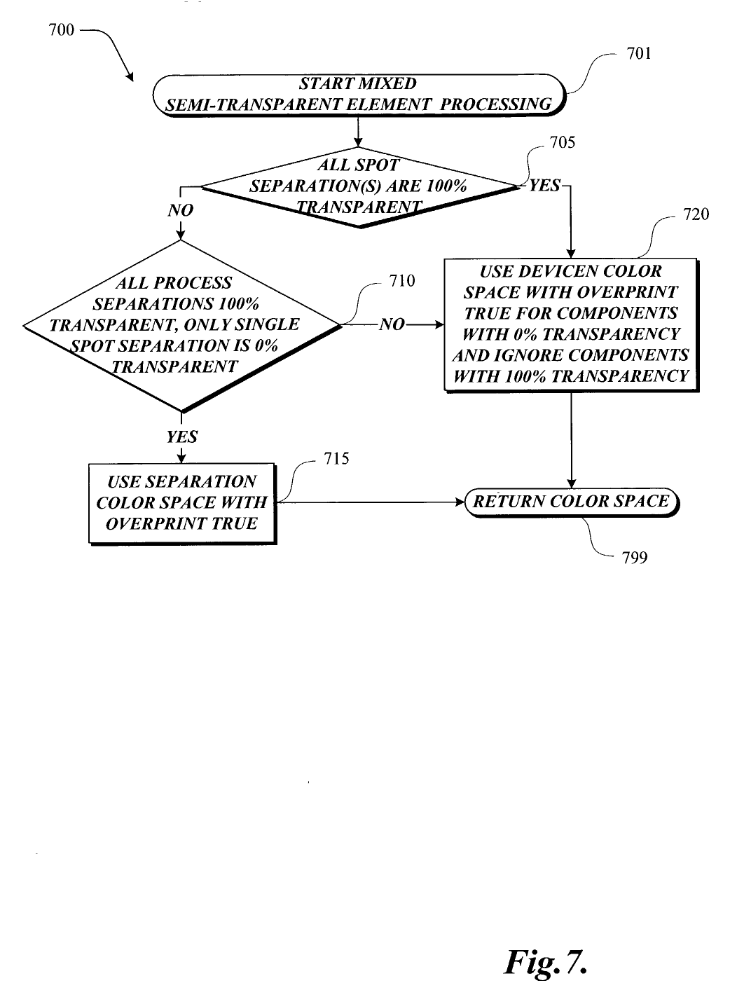

If in decision block 615 it was determined that the separations are mixed separations, processing proceeds to a mixed processing subroutine 700. The mixed processing subroutine processes mixed semi-transparent linework elements. A mixed processing subroutine 700 suitable for use in FIG. 6 is illustrated in FIG. 7 and described below. After returning from the mixed processing subroutine the semitransparent element linework processing subroutine 600 logic continues to block 699 where the color space is returned to the color space determination subroutine 400 (FIG. 4).

FIG. 7 illustrates a mixed semitransparent separations processing subroutine 700 suitable for use in FIG. 6. The mixed semitransparent separations subroutine 700 begins at block 701 and proceeds to a decision block 705 where a test is made to determine whether all spot separations of the linework element are 100% transparent. If the spot separation of the linework elements are not 100% transparent, processing proceeds to decision block 710 where a test is made to determine whether all process separations are 100% transparent and only a single spot separation is 0% transparent. If decision block 710 is true, processing proceeds to block 715 where a separation color space with over print true is used. Then, in block 799, processing returns to the calling subroutine, i.e., the semitransparent element processing subroutine 600 (FIG. 6). If, however, decision block 710 is false or untrue because all process separations are not 100% transparent with a single spot separation that is 0% transparent, processing proceeds to block 720. Similarly, if in decision block 705, it was found that the spot separation of the linework element is 100% transparent, processing continues to block 720, where a DeviceN color space with over print true for components with 0% transparency is used and components with 100% transparency are ignored. This color space is then returned, in block 799, to the calling routine, i.e., the semitransparent element processing subroutine 600 (FIG. 6).

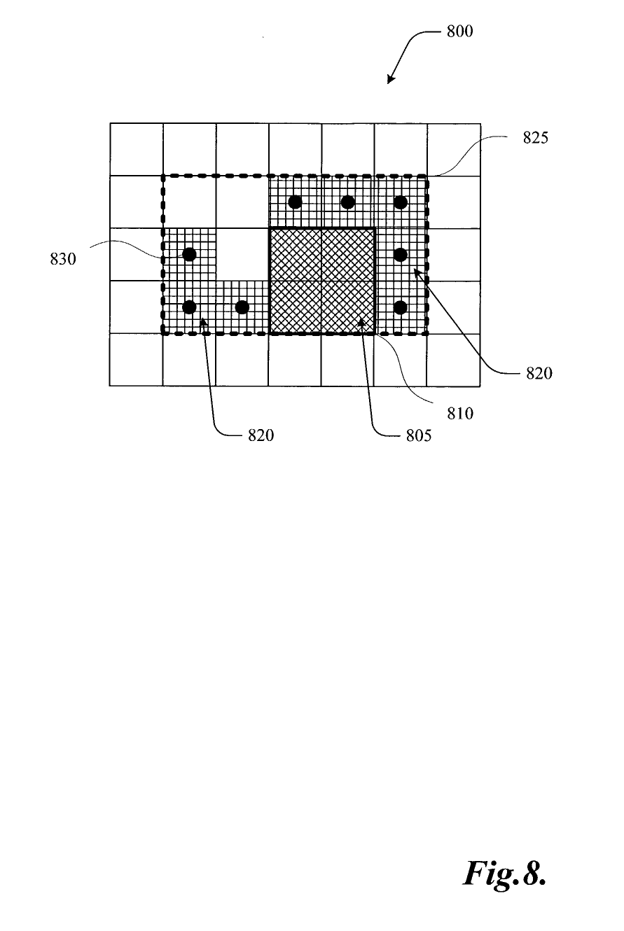

FIG. 8 illustrates in simplified form an exemplary image tile processed by an embodiment of the present invention. More specifically, FIG. 8 illustrates a rectangular tile 800 seven pixels wide and five pixels high. FIG. 8 also illustrates a rectfill 805 of LW one color that is intended to fill the four pixels shown with diagonal crosshatching in FIG. 8. The rectfill 805 has a rectfill boundary 810 that encompasses the rectfill 805. Also shown in FIG. 8 is an imagemask 820 of another LW color composed of eight grid-lined pixels with center dots 830. This imagemask has a bounding box 825 indicated by dotted lines. Note that the bounding box 825 is the minimum size needed to encompass all the pixels in the imagemask 820. One of ordinary skill in the art will appreciate that this is a simplified and non-limiting example used for illustrative purposes only to aid in the understanding of the present invention.

As will be readily appreciated by those skilled in the art and others, the present invention provides a method to increase data processing efficiency. This efficiency is accomplished by reducing the number of bits required to represent LW elements of an image to less than originally required. Therefore, a file containing image data can be more easily stored and processed when rendering the image. In many cases, data reduction makes rendering an image possible with equipment that could not render the image due to limited memory capacity. In other cases, data reduction speeds up processing time.

While a preferred embodiment of the invention has been illustrated and described, it will be appreciated that various changes can be made therein without departing from the spirit and scope of the invention.

The embodiments of the invention in which an exclusive property or privilege is claimed are defined as follows:

1. A computer-implemented method of increasing the efficiency of processing digital images containing linework data, the method comprising:
determining a color space for the linework elements of an original image;
dividing said original image into a plurality of tiles;
for a each tile, determining for a color, a rectfill criterion for representing said color as at least one rectfill;
determining that said rectfill criterion is met; and
representing said color with at least one rectfill.

2. The method of claim 1, further comprising determining for a first tile that all linework colors in said first tile are not transparent;
determining that the number of pixels of the most common color in said first tile exceeds a background threshold; and
representing a background of said first tile with a single rectfill of said most common color.

3. The method of claim 1, further comprising representing said color with an imagemask.

4. The method of claim 3 wherein the boundary box of said imagemask is the smallest possible bounding box of pixels.

5. The method of claim 1 wherein said rectfill criterion is a rectfill threshold.

6. The method of claim 5 wherein said rectfill threshold is a fixed threshold.

7. The method of claim 5 wherein said rectfill threshold corresponds to the size of a tile.

8. The method of claim 7 wherein said rectfill threshold is calculated such that any imagemask used to paint said color is less efficient if the number of rectfills in a tile is less than said rectfill threshold.

9. The method of claim 1 wherein said rectfill criterion is a predetermined number of line elements.

10. The method of claim 1 wherein said rectfill criterion is a predetermined pixel coverage.

11. The method of claim 1 wherein said tiles fall in the range of 512 to 2048 pixels by 512 to 4096 pixels.

12. A computer-implemented method of increasing the efficiency of processing digital images containing linework data, the method comprising:
determining a color space for the linework elements of an original image;
dividing said original image into a plurality of tiles;
for a each tile, determining for a color, a rectfill criterion for representing said color as at least one rectfill;
determining that said rectfill criterion is not met; and
representing said color with at least one imagemask.

13. The method of claim 12 wherein said imagemask has a smallest bounding box of pixels.

14. A computerized apparatus comprising a processor and a memory, and operative to perform the method of any of claims 1-11.

15. A computerized apparatus comprising a processor and a memory, and operative to perform the method of any of claims 12-13.

16. A computer-readable medium containing computer executable instructions for performing the method of any of claims 1-11.

17. A computer-readable medium containing computer executable instructions for performing the method of any of claims 12-13.
